(19) United States
(12) Patent Application Publication
(10) Pub. No.: US 2010/0136275 A1
(43) Pub. Date: Jun. 3, 2010

(54) FILM FOR MANUFACTURING SEMICONDUCTOR DEVICE AND METHOD OF MANUFACTURING THE SAME

(76) Inventor: Yasuhiro Amano, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 12/629,296

(22) Filed: Dec. 2, 2009

(30) Foreign Application Priority Data
Dec. 2, 2008 (JP) 2008-307674

(51) Int. Cl. B32B 33/00; B32B 38/00

(52) U.S. Cl. 428/40.1; 156/229

(57) ABSTRACT

A present invention relates to a film for manufacturing a semiconductor device in which a cover film is pasted onto a laminated film, wherein the shrinkage in the longitudinal direction and in the lateral direction in the laminated film after peeling the cover film and leaving for 24 hours at a temperature of 23±2° C. is in a range of 0 to 2% compared to the laminated film before pasting of the cover film.

### FIELD OF THE INVENTION

The present invention relates to a film for manufacturing a semiconductor device that is used to manufacture a semiconductor device and a method of manufacturing the film.

### BACKGROUND OF THE INVENTION

A semiconductor wafer on which a circuit pattern is formed is diced into semiconductor chips (a dicing step) after the thickness is adjusted by backside polishing depending on necessity. Next, the semiconductor chips are fixed onto an adherent such as a lead frame with an adhesive (a die attaching step), and then they are transferred to a bonding step. In the die attaching step, the adhesive has been applied onto a lead frame or the semiconductor chips. However, it is difficult to obtain a uniform adhesive layer and a special device and a long time are necessary to apply the adhesive with this method. Because of this, a dicing die-bonding film is proposed that adheres and holds a semiconductor wafer in the dicing step and also acts as an adhesive layer for fixing chips that is necessary in a mounting step (for example, refers to Japanese Patent Application Laid-Open No. 60-57642).

The dicing die-bonding film described in JP-A No. 60-57642 is composed of an adhesive layer that is formed on a supporting base material so that it can be peeled. That is, the dicing die-bonding film is made so that after the semiconductor wafer is diced while being held by the adhesive layer, the semiconductor chip is peeled together with the adhesive layer by stretching the supporting base material, the semiconductor chips are individually recovered, and then they are fixed onto an adherend such as a lead frame with the adhesive layer interposed therebetween.

There is a case that a dicing die-bonding film of this type is cured when it is placed in a high temperature and high humidity environment or when it is stored for a long period of time in a condition of which a load is applied. As a result, a decrease of fluidity of the adhesive layer, a decrease of a holding power to a semiconductor wafer, and a decrease of the peeling property after dicing are brought about. Because of this, the dicing die-bonding film is often transported while being kept in a frozen condition of −30 to −10° C. or a refrigerated condition of −5 to 10° C. With this, the film characteristics can be maintained for a long period of time.

However, a conventional dicing die-bonding film has been produced by separately producing each of a dicing film and a die-bonding film and then by pasting both together because of limitations in the manufacturing process. Because of this, from a viewpoint of preventing sag, winding deviation, position deviation, wrinkles, etc. from occurring in the production process of each film, production is performed while applying a tensile force to each film when the film is conveyed with a roll. As a result, a residual stress remains in the produced dicing die-bonding film, and with this, there is a problem that peeling of both layers occurs at the interface of a pressure-sensitive adhesive layer and the adhesive layer after the dicing die-bonding film is transported in the low-temperature condition described above or is stored for a long period of time. There is also a problem that a phenomenon occurs in which the films float off the surface due to shrinking of the dicing die-bonding film.

### SUMMARY OF THE INVENTION

The present invention is performed to solve the above-described problems, and its objective is to provide a film for manufacturing a semiconductor device that is capable of preventing peeling of both films at the interface of the pressure-sensitive adhesive layer and the adhesive layer and a so-called film floating phenomenon from occurring even after the dicing die-bonding film is transported in a low-temperature condition or is stored for a long period of time, and a manufacturing method of the film.

The present inventors investigated a film for manufacturing a semiconductor device and a method of manufacturing the film to solve the conventional problem points. As a result, they found that peeling at the interface of the pressure-sensitive adhesive layer and the adhesive layer and a so-called film floating phenomenon can be prevented from occurring even after the dicing die-bonding film is transported in a low-temperature condition or is stored for a long period of time by pasting a cover film to a laminated film in a condition of which the cover film is stretched, and came to the completion of the present invention.

That is, in order to solve the above-mentioned problems, the present invention relates to a film for manufacturing a semiconductor device in which a cover film is pasted onto a laminated film, wherein the shrinkage in the longitudinal direction and in the lateral direction in the laminated film after peeling the cover film and leaving for 24 hours at a temperature of 23±2° C. is in a range of 0 to 2% compared to the laminated film before pasting of the cover film.

When the cover film is pasted to the laminated film in a condition of which the residual stress remains due to the stretching during the conveyance by a roll for example, there is a case that interface peeling occurs between films that are laminated caused by the residual stress when it is transported in a frozen condition of −30 to −10° C. or in a low-temperature condition of −5 to 10° C. or after it is stored for a long period of time. Further, there is a case that a film floating phenomenon of the cover film occurs due to the laminated film shrinking. However, with the above-described configuration, by making the shrinkage in the longitudinal direction and in the lateral direction in the laminated film after peeling the cover film and leaving the film at the temperature of 23±2° C. for 24 hours to be in a range of 0 to 2% compared to the laminated film before pasting of the cover film, the peeling at the interface between the films caused by the residual stress and the generation of film floating can be prevented. “Laminated film” in the present invention refers to a film in which films of at least two layers are laminated.

It is preferable that the laminated film is a film in which an adhesive layer is provided onto a pressure-sensitive adhesive layer which is provided on a base material of a dicing film. When the laminated film is a dicing die-bonding film, peeling of the pressure-sensitive adhesive layer and the adhesive layer at the interface and the occurrence of the film floating phenomenon caused by the remaining residual stress can be prevented.

It is preferable that the glass transition temperature of a polymer resin component in the adhesive layer is in a range of −20 to 50° C., and the tensile storage modulus at 23° C. before curing is in a range of 50 to 2000 MPa. By making the glass transition temperature of a polymer resin component to be −20° C. or more, the tack property of the adhesive layer is suppressed from being large in a B-stage state, and a good handling property can be maintained. Further, attachment of a part of the pressure-sensitive adhesive that is melted to a semiconductor chip can be prevented when dicing. As a result, a good pickup property of the semiconductor chip can be maintained. On the other hand, by making the glass transition temperature to be 50° C. or less, a decrease of the fluidity of the adhesive layer can be prevented. A good tackiness with the semiconductor wafer can be also maintained. Further, by making the tensile storage modulus to be 50 MPa or more, attachment of a part of the pressure-sensitive adhesive that is melted to a semiconductor chip can be prevented when dicing. On the other hand, by making the tensile storage modulus to be 2000 MPa or less, a good tackiness with the semiconductor wafer or substrate can be also maintained.

It is preferable that the pressure-sensitive adhesive layer of the dicing film is an ultraviolet ray curing type, and the tensile modulus of the dicing film at 23° C. after curing the pressure-sensitive adhesive layer with an ultraviolet ray is in a range of 1 to 170 MPa. By making the tensile modulus of the dicing film to be 1 MPa or more, a good pickup property can be maintained. On the other hand, by making the tensile modulus to be 170 MPa or less, generation of chip fly when dicing can be prevented.

In order to solve the above-mentioned problems, the present invention relates to a method of manufacturing the film for manufacturing a semiconductor device in which the cover film is laminated on the laminated film, wherein the cover film is pasted to the laminated film in a condition of which the cover film is stretched by applying a tensile force on the cover film in the longitudinal direction, and the shrinkage in the longitudinal direction and the lateral direction in the laminated film after peeling the cover film and leaving it for 24 hours at 23±2° C. is adjusted to be in a range of 0 to 2% to the laminated film before pasting the cover film.

With the above-described method, the cover film is pasted to the laminated film in a condition that the cover film is stretched by applying a tensile force in the longitudinal direction. Therefore, the effect of the residual stress existing in the laminated film can be decreased. With this, a film for manufacturing a semiconductor device can be manufactured without the interface peeling caused by the residual stress between the laminated films and without the film floating phenomenon even when it is transported in a frozen condition of −30 to −10° C. or a low-temperature condition of −5to 10° C. or when it is stored for a long period of time.

It is preferable that the cover film is pasted to the laminated film by stretching in the longitudinal direction at 1.001 to 1.1 times its initial state. By adopting a laminated film in which the adhesive layer is laminated on the die-bonding film, manufacturing of a dicing die-bonding film as the film for manufacturing a semiconductor device becomes possible. When adopting the laminated film having the above-described configuration, only the base material maintains the shape and the laminated structure of the film as a support when a base separator is peeled from the adhesive layer. Because of this, the laminated film becomes easily stretched during conveyance, and as a result, residual stress is easily generated in the laminated film. However, with the above-described method, even in manufacturing of such a dicing die-bonding film, the dicing die-bonding film can be manufactured without the peeling at the interface of the pressure sensitive adhesive layer and the adhesive layer and without the film floating phenomenon of the cover film that are caused by the residual stress by pasting the cover film in a stretched condition.

In the above-described method, the cover film is preferably pasted to the laminated film by stretching the cover film in the longitudinal direction at 1.001 to 1.1 times of its initial state. By applying the tensile force to the cover film in its longitudinal direction within this range, the peeling between the films in the laminated film and the film floating phenomenon of the cover film can be prevented.

The present invention carries out the effects as described below with means that are explained above.

That is, according to the film for manufacturing a semiconductor device of the present invention, by making shrinkage of the laminated film in the longitudinal direction and in the lateral direction after peeling the cover film and leaving the film at a temperature of 23±2° C. for 24 hours to be in a range of 0 to 2% compared to the laminated film before pasting of the cover film, the interface peeling between films and generation of the film floating caused by residual stress can be prevented even when it is transported in a frozen condition of −30 to −10° C. or in a low-temperature condition of −5 to 10° C. or after it is stored for a long period of time. As a result, a film for manufacturing a semiconductor device can be provided that is capable of manufacturing a semiconductor device with an improved yield.

According to the manufacturing method of the film for manufacturing a semiconductor device of the present invention, because the cover film is pasted to the laminated film in a condition of which the tensile force is applied to the cover film in its longitudinal direction and in a stretched condition, the effect of the residual stress existing in the laminated film can be decreased. As a result, a film for manufacturing a semiconductor device can be manufactured without the peeling of the interface between the films that are laminated and the film floating phenomenon of the cover film that are caused by the residual stress even when transporting in a low-temperature condition or after storing for a long period of time.

### BRIEF DESCRIPTION OF THE DRAWINGS

FIG. 1 is a sectional drawing showing an outline of the dicing die-bonding film of one embodiment of the present invention.

FIG. 2(a) is a schematic drawing for explaining the manufacturing process of the dicing die-bonding film. FIG. 2(b) is a sectional drawing showing an outline of the die-bonding film. FIG. 2(c) is a sectional drawing showing an outline of the film in which the cover film is provided onto the laminated film.

FIG. 3 is an explanatory drawing for explaining the pasting step of a laminated film and a cover film.

FIG. 4 is an explanatory drawing showing a state of applying a tensile force to the cover film.

### DESCRIPTION OF THE EMBODIMENTS

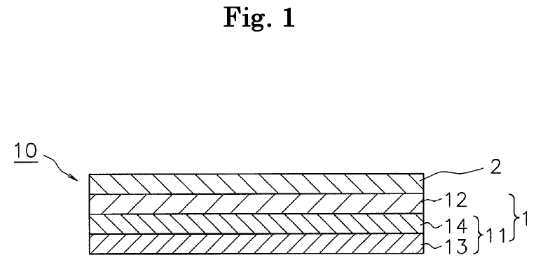

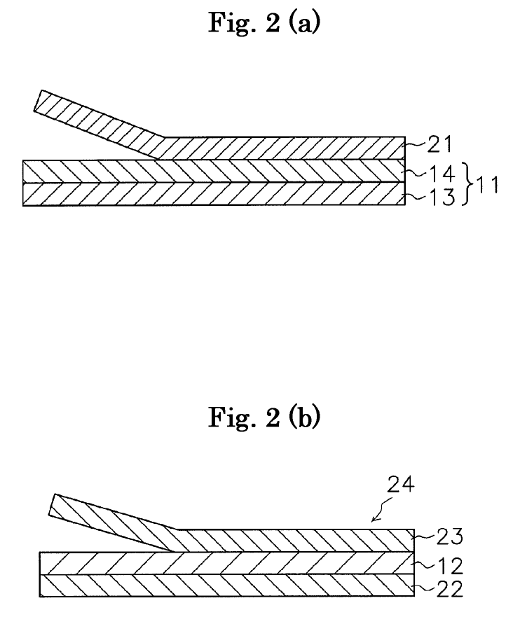

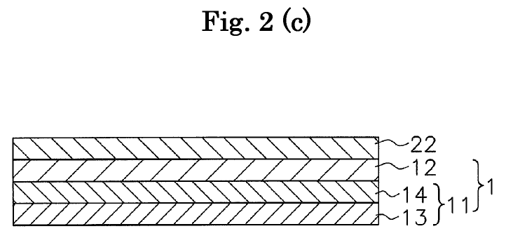

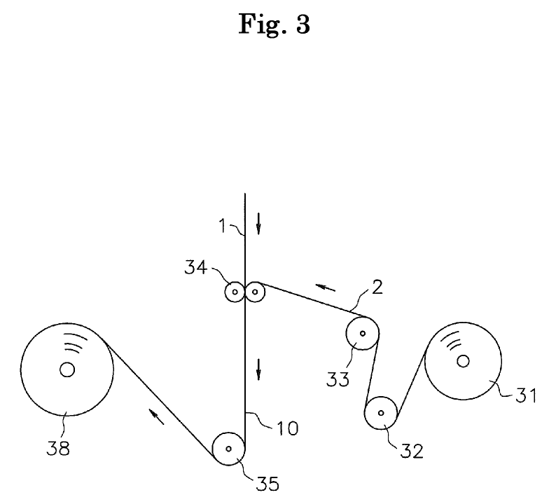

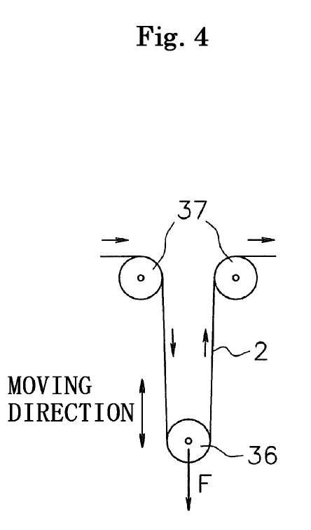

The film for manufacturing a semiconductor device according to the present embodiment is explained using a dicing die-bonding film as an example. FIG. 1 is a sectional drawing showing an outline of the dicing die-bonding film according to the present embodiment. FIG. 2(a)is a schematic drawing for explaining the manufacturing process of the dicing die-bonding film. FIG. 2(b) is a sectional drawing showing an outline of the die-bonding film. FIG. 2(c) is a sectional drawing showing an outline of the film in which the cover film is provided onto the laminated film. FIG. 3 is an explanatory drawing for explaining the pasting step of a laminated film and a cover film. FIG. 4 is an explanatory drawing showing a state of applying a tensile force to the cover film.

As shown in FIG. 1, a dicing die-bonding film 10 according to the present embodiment has a structure in which an adhesive layer 12 and a cover film 2 are laminated on a dicing film 11 one by one. The dicing film 11 has a structure in which a pressure-sensitive adhesive layer 14 is laminated on a base material 13 (refer to FIG. 2(a)).

The dicing film 11 can be produced in the following way for example. First, the base material 13 can be formed with a conventionally known film making method. Examples of the film making method include a calendar film-making method, a casting method in an organic solvent, an inflation extrusion method in a closed system, a T die extrusion method, a co-extrusion method, and a dry lamination method.

Next, a coated film is formed by applying a pressure-sensitive adhesive composition onto the base material 13, and then the pressure-sensitive adhesive layer 14 is formed by drying (by heat-crosslinking if necessary) the coated film under a prescribed condition. The application method is not especially limited, and examples include roll coating, screen coating, and gravure coating. The drying condition can be appropriately set depending on the thickness, the material, etc. of the coated film. Specifically, it is performed at a drying temperature of 80 to 150° C. and a drying time of 0.5 to 5 minutes for example. The pressure-sensitive adhesive layer 14 may be also formed by forming the coated film by applying the pressure-sensitive adhesive composition onto a first separator 21 and then by drying the coated film in the above-described drying condition. After that, the pressure-sensitive adhesive layer 14 is pasted to the base material 13 together with the first separator 21. With this, the dicing film 11 can be produced in which the pressure-sensitive adhesive layer 14 is protected by the first separator 21 (refer to FIG. 2(a)).

The dicing film 11 can be produced in the following way when a pressure-sensitive adhesive layer consisting of an ultraviolet-ray curing-type pressure-sensitive adhesive that is cured by an ultraviolet ray in advance is adopted as the pressure-sensitive adhesive layer 14. That is, a coated film is formed by applying an ultraviolet-ray curing-type pressure-sensitive adhesive composition onto the base material 13, and then a pressure-sensitive adhesive layer precursor is formed by drying (by heat-crossing if necessary) the coated film under a prescribed condition. The same coating method, coating condition, and drying condition as described above can be used. Further, the coated film may be formed by applying the ultraviolet-ray curing-type pressure-sensitive adhesive composition onto the first separator 21, and then the pressure-sensitive adhesive layer precursor may be formed by drying the coated film under the above-described drying condition. After that, the pressure-sensitive adhesive layer precursor is transferred onto the base material 13. Ultraviolet-ray irradiation is performed under a prescribed condition on the pressure-sensitive adhesive layer precursor that is formed in such way, and with this, the pressure-sensitive adhesive layer 14 is formed. As the irradiation condition of the ultraviolet ray, the integrated radiation is preferably in a range of 30 to 1000 mJ/cm², and more preferably in a range of 100 to 500 mJ/cm². When the irradiation by the ultraviolet ray is less than 30 mJ/cm², there is a case that the curing of the pressure-sensitive adhesive layer 14 becomes insufficient. As a result, the adhesion with the die-bonding film increases and a decrease of the pickup property is brought about. Further, there is a case that adhesive residue occurs on the die-bonding film after picking up. On the other hand, when the integrated radiation exceeds 1000 mJ/cm² , there is a case that thermal damage is given to the base material 13. Further, the curing of the pressure-sensitive adhesive layer 14 progresses excessively, the tensile modulus becomes too large, and the expansion property decreases. Furthermore, the adhesive strength decreases excessively, and with this, there is a case that chip fly is generated during dicing of a semiconductor wafer.

First, the die-bonding film 24 shown in FIG. 2(b) is produced, and then the adhesive layer 12 is transferred and laminated onto the pressure-sensitive adhesive layer 14 of the dicing film 11. The die-bonding film 24 has a structure in which the adhesive layer 12 and a second separator 23 are laminated on a base separator 22 one by one.

The die-bonding film 24 is produced in the following way for example.

That is, a coated film is formed by applying an adhesive composition solution to form the adhesive layer 12 onto the base separator 22 so that the coated film has a prescribed thickness, and then the adhesive layer 12 is formed by drying the coated film under a prescribed condition. The application method is not especially limited, and examples include roll coating, screen coating, and gravure coating. The drying condition can be appropriately set depending on the thickness and the materials of the coated film. Specifically, it is performed at a drying temperature of 70 to 160° C. and a drying time of 1 to 5 minutes. The adhesive layer 12 may be also formed by forming the coated film by applying the pressure-sensitive adhesive composition onto the second separator 23 and then by drying the coated film with the above-described drying condition. After that, the adhesive layer 12 is pasted to the base separator 22 together with the second separator 23. With this, the die-bonding film 24 can be produced in which the adhesive layer 12 and the second separator 23 are laminated on the base separator 22 one by one (refer to FIG. 2(b)).

The dicing die-bonding film 10 according to the present embodiment is produced by pasting the dicing film 11 and the die-bonding film 24 together. Specifically, the production process is as follows.

That is, the second separator 23 is peeled from the die-bonding film 24 as the first separator 21 is peeled from the dicing film 11, and the adhesive layer 12 and the pressure-sensitive adhesive layer 14 are pasted together so that both layers become the pasting surface (refer to FIG. 2(c)). The pasting of the adhesive layer 12 and the pressure-sensitive adhesive layer 14 can be performed by pressing for example. At this time, the laminating temperature is not especially limited, it is preferably 30 to 50° C., and more preferably 35 to 45° C. for example. The line pressure is not especially limited, it is preferably 0.1 to 20 kgf/cm, and more preferably 1 to 10 kgf/cm.

Next, the base separator 22 on the adhesive layer 12 is peeled, and with this, a laminated film 1 can be obtained in which the pressure-sensitive adhesive layer 14 and the adhesive layer 12 are laminated on the base material 13 one by one. Next, the cover film 2 is pasted on the adhesive layer 12 in the laminated film 1 (refer to FIG. 3). Here, the laminated film 1 is preferably transported in a condition of which tensile force is not applied in its longitudinal direction as much as possible. This is because only the base material 13 has a structure in which the film shape and laminated structure of the dicing die-bonding film are maintained as a support, and as a result, the laminated film 1 is in condition that it is easily stretched. The tensile force is especially preferably in a range of 10 to 25 N.

The cover film 2 is transported while being fed from a feed roll 31 in which the cover film 2 is wound up in a roll and being directed by guide rolls 32 and 33. The guide rolls 32 and 33 are rolls that rotate freely. However, the guide rolls 32 and 33 of the present invention are not limited to be a roll, and they may be non-rotational fixed types for example. The shape of the guide rolls 32 and 33 is not especially limited, and it is suitable if at least the surface contacting the cover film 2 is at least a curved surface. Therefore, in section, it can have a semicircular shape, an oval shape, a pie shape, etc. By making the guide rolls 32 and 33 to have these shapes, friction resistance at the contact surface of the cover film 2 with the guide rolls 32 and 33 is prevented from becoming excessively large, and the transportation of the cover film 2 can be made easy.

The pasting of the cover film 2 to the laminated film 1 is performed in a stretched condition by applying a prescribed tensile force in its longitudinal direction in advance. The pasting is preferably performed by pressing for example. The method of applying the tensile force to the cover film 2 is not especially limited, and an example is a method using a dancer roll 36 shown in FIG. 4. The tensile force can be applied in the longitudinal direction of the cover film 2 by arranging the dancer roll 36 between a pair of fixed rolls 37 and allowing it to move in the up and down directions. The stretching of the cover film 2 is performed so that the ratio becomes in a range of 1.001 to 1.1 times its initial state, and preferably 1.001 to 1.01 times its initial state. When the ratio of stretching is less than 1.001 times, there is a case the effect of the invention cannot be obtained. On the other hand, when it exceeds 1.1 times, the cover film 2 is deformed by stretching, and there is a case that wrinkles and curls are generated. The “longitudinal direction” means the MD (machine direction) of the film, and the “lateral direction” described later means the TD (transverse direction) that running through is perpendicular to the MD.

The pasting of the cover film 2 to the laminated film 1 can be performed with nip rolls 34 for example. Each of the nip rolls 34 has a roll shape that freely rotates. The laminating temperature is not especially limited, and it is preferably 18 to 28° C., and more preferably 20 to 25° C. for example. The pasting pressure (nip pressure) is not especially limited, and it is preferably 0.1 to 0.5 MPa, and more preferably 0.1 to 0.4 MPa for example. With this, the dicing die-bonding film 10 according to the present embodiment is produced.

After that, the dicing die-bonding film 10 is transported via a guide roll 35, and wound in a roll shape by a winding roll 38. Shrinkage of the dicing die-bonding film 10 that is produced in such manner is suppressed after and before the pasting of the cover film 2, and the shrinkage is controlled in a range of 0 to 2% in both the longitudinal direction and the lateral direction. That is, with the manufacturing method according to the present embodiment, shape stability of the dicing die-bonding film is excellent. When the shrinkage in the longitudinal direction or the lateral direction is less than 0%, that is when the dicing die-bonding film 10 is stretched, a sag and position deviation are generated in the dicing die-bonding film 10 when mounting a semiconductor wafer. On the other hand, when the shrinkage is larger than 2%, peeling of the adhesive layer 12 and the pressure-sensitive adhesive layer 14 occurs at the interface. As a result, the semiconductor chip that is produced cannot be adhered and fixed sufficiently when dicing the semiconductor wafer, damage of the semiconductor chip due to chip fly and chipping is generated, and the yield decreases. The shrinkage in the longitudinal direction and the lateral direction is more preferably 0 to 1%, and especially preferably 0 to 0.5%.

The shrinkage can be calculated as follows. In the laminated film before pasting the cover film 2, the length in the MD and the width in the TD are measured, and marking is performed on the backside (the surface opposite to the surface where the pressure-sensitive adhesive layer 14 is formed) of the base material 13. Next, the cover film 2 is peeled from the dicing die-bonding film 10 under the environment of temperature 23±2° C. and relative humidity 55±5%, and the dicing die-bonding film 10 is left for 24 hours. After that, the length in the MD and the width in the TD of the dicing die-bonding film 10 are measured. The shrinkage in the MD and the TD is calculated with the following formula using the obtained measurement values.

Shrinkage (%)=[(Distance in the MD or the TD before pasting)−(Distance in the MD or the TD after pasting)/(Distance in the MD or the TD before pasting)]×100

Next, each of the parts that configure the dicing die-bonding film 10 is explained.

The base material 13 is a strength matrix of the dicing die-bonding film 10. Examples thereof include polyolefin such as low-density polyethylene, straight chain polyethylene, intermediate-density polyethylene, high-density polyethylene, very low-density polyethylene, random copolymer polypropylene, block copolymer polypropylene, homopolypropylene, polybutene, and polymethylpentene; an ethylene-vinylacetate copolymer; an ionomer resin; an ethylene(meth)acrylic acid copolymer; an ethylene(meth)acrylic acid ester (random or alternating) copolymer; an ethylene-butene copolymer; an ethylene-hexene copolymer; polyurethane; polyester such as polyethyleneterephthalate and polyethylenenaphthalate; polycarbonate; polyetheretherketone; polyimide; polyetherimide; polyamide; whole aromatic polyamides; polyphenylsulfide; aramid (paper); glass; glass cloth; a fluorine resin; polyvinyl chloride; polyvinylidene chloride; a cellulose resin; a silicone resin; metal (foil); and paper. When the pressure-sensitive adhesive layer 14 is an ultraviolet ray curing type, the base material 13 is preferably a layer having an ultraviolet ray transmission property among the examples described above.

Further, the material of the base material 13 includes a polymer such as a cross-linked body of the above resins. The above plastic film may be also used unstretched, or may be also used on which a monoaxial or a biaxial stretching treatment is performed depending on necessity. According to resin sheets in which heat shrinkable properties are given by the stretching treatment, etc., the adhesive area of the pressure-sensitive adhesive layer 14 and the adhesive layer 12 is reduced by thermally shrinking the base material 13 after dicing, and the recovery of the semiconductor chips can be facilitated.

A known surface treatment such as a chemical or physical treatment such as a chromate treatment, ozone exposure, flame exposure, high voltage electric exposure, and an ionized radiation treatment, and a coating treatment by an undercoating agent (for example, a tacky substance described later) can be performed on the surface of the base material 13 in order to improve adhesiveness, holding properties, etc. with the adjacent layer.

The same type or different type of base material can be appropriately selected and used as the base material 13, and a base material in which a plurality of types are blended can be used depending on necessity. Further, a vapor-deposited layer of a conductive substance composed of a metal, an alloy, an oxide thereof, etc. and having a thickness of about 30 to 500 angstrom can be provided on the base material 13 in order to give an antistatic function to the base material 13. The base material 13 may be a single layer or a multi layer of two or more types.

The thickness of the base material 13 can be appropriately decided without limitation particularly. However, it is generally about 5 to 200 μm. The thickness of the base material 13 is not especially limited as long as it is a thickness that can tolerate the tensile force of the adhesive layer 12 by heat shrinking.

The pressure-sensitive adhesive that is used in the formation of the pressure-sensitive adhesive layer 14 is not especially limited, and a general pressure-sensitive adhesive such as an acrylic pressure-sensitive adhesive and a rubber pressure-sensitive adhesive can be used for example. An acrylic pressure-sensitive adhesive having an acrylic polymer as abase polymer is preferable as the pressure-sensitive adhesive from the respect such as the cleaning property of electronic parts that dislike contamination such as a semiconductor wafer and a glass when cleaned with super pure water or an organic solvent such as alcohol.

Examples of the acrylic polymer include acrylic polymers each comprising, as one or more monomer components, one or more selected from alkyl esters of (meth)acrylic acid (for example, linear and branched alkyl esters thereof each having an alkyl group having 1 to 30 carbon atoms, in particular, 4 to 18 carbon atoms, such as methyl ester, ethyl ester, propyl ester, isopropyl ester, butyl ester, isobutyl ester, s-butyl ester, t-butyl ester, pentyl ester, isopentyl ester, hexyl ester, heptyl ester, octyl ester, 2-ethylhexyl ester, isooctyl ester, nonyl ester, decyl ester, isodecyl ester, undecyl ester, dodecyl ester, tridecyl ester, tetradecyl ester, hexadecyl ester, octadecyl ester, and eicosyl ester thereof) and cycloalkyl esters of (meth)acrylic acid (for example, cyclopentyl ester and cyclohexyl ester thereof). The wording “esters of (meth)acrylic acid” means esters of acrylic acid and/or methacrylic acid. All of the words including “ (meth)” in connection with the present invention have an equivalent meaning.

The acrylic polymer may optionally contain a unit corresponding to a different monomer component copolymerizable with the above-mentioned alkyl ester of (meth)acrylic acid or cycloalkyl ester thereof in order to improve the cohesive force, heat resistance or some other property of the polymer. Examples of such a monomer component include carboxyl-containing monomers such as acrylic acid, methacrylic acid, carboxyethyl (meth)acrylate, carboxypentyl (meth)acrylate, itaconic acid, maleic acid, fumaric acid, and crotonic acid; acid anhydride monomers such as maleic anhydride, and itaconic anhydride; hydroxyl-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxylmethylcyclohexyl)methyl (meth)acrylate; sulfonic acid group containing monomers such as styrenesulfonic acid, allylsulfonic acid, 2-(meth)acrylamide-2-methylpropanesulfonic acid, (meth)acrylamidepropanesulfonic acid, sulfopropyl (meth)acrylate, and (meth)acryloyloxy naphthalenesulfonic acid; phosphoric acid group containing monomers such as 2-hydroxyethylacryloyl phosphate; acrylamide; and acrylonitrile. These copolymerizable monomer components may be used alone or in combination of two or more thereof. The amount of the copolymerizable monomer(s) to be used is preferably 40% or less by weight of all the monomer components.

For crosslinking, the acrylic polymer can also contain multifunctional monomers if necessary as the copolymerizable monomer component. Such multifunctional monomers include hexane dioldi(meth)acrylate, (poly)ethylene glycol di(meth)acrylate, (poly)propylene glycol di(meth)acrylate, neopentyl glycol di(meth)acrylate, pentaerythritol di(meth)acrylate, trimethylol propane tri(meth)acrylate, pentaerythritol tri(meth)acrylate, dipentaerythritol hexa(meth)acrylate, epoxy (meth)acrylate, polyester (meth)acrylate, urethane (meth)acrylate etc. These multifunctional monomers can also be used as a mixture of one or more thereof. From the viewpoint of adhesiveness etc., the use amount of the multifunctional monomer is preferably 30 wt % or less based on the whole monomer components.

The acryl polymer can be obtained by polymerizing a single monomer or a monomer mixture of two or more types. The polymerization can be performed with any of methods such as solution polymerization, emulsifying polymerization, bulk polymerization, and suspension polymerization. From the viewpoint of prevention of contamination to a clean adherend, etc., the content of a low molecular weight substance is preferably small. From this viewpoint, the weight average molecular weight of the acryl polymer is preferably 30,000 or more, and more preferably about 400,000 to 3,000,000.

For the above-mentioned adhesive, an external crosslinking agent may be appropriately used in order to heighten the number-average molecular weight of the acrylic polymer or the like as the base polymer. A specific example of the method of using the external crosslinking agent maybe a method of adding, to the base polymer, the so-called crosslinking agent, such as a polyisocyanate compound, epoxy compound, aziridine compound or melamine type crosslinking agent, so as to cause crosslinking reaction. In the case that the external crosslinking agent is used, the amount thereof is appropriately decided in accordance with the balance with the amount of the base polymer to be crosslinked and further the use purpose of the adhesive. In general, the amount of the external cross-linking agent is preferably 5 or less parts by weight to 100 parts by weight of the base polymer, more preferably about 0.1 to 5 parts by weight. If necessary, any conventional additive such as a tackifier, and an antioxidant may be added in addition to the above components.

The pressure-sensitive adhesive layer 14 can be formed with an ultraviolet ray curing-type pressure-sensitive adhesive. The ultraviolet ray curing-type pressure-sensitive adhesive can easily deteriorate the adhesive strength by increasing the degree of crosslinking with irradiation of an ultraviolet ray, and by irradiating only the portion corresponding to the semiconductor wafer pasting portion of the pressure-sensitive adhesive layer 14 with the ultraviolet ray, a difference of adhesive strength with the other portion can be provided.

The tensile modulus of the dicing film 11 at 23° C. after the pressure-sensitive adhesive layer 14 is cured with ultraviolet ray is preferably in a range of 1 to 170 MPa. By making the tensile modulus to be 1 MPa or more, a good pickup property can be maintained. On the other hand, by making the tensile modulus to be 170 MPa or less, generation of chip fly when dicing can be prevented. The irradiation of the ultraviolet ray is preferably performed with 30 to 1000 mJ/cm² of ultraviolet ray integrated radiation for example. By making the ultraviolet ray integrated radiation to be 30 mJ/cm² or more, the pressure-sensitive adhesive layer 14 can be cured sufficiently, and an excessive adhesion with the adhesive layer 12 can be prevented. As a result, a good pickup property can be exhibited when picking up a semiconductor chip. Further, the pressure-sensitive adhesive of the pressure-sensitive adhesive layer 14 can be prevented from attaching to the adhesive layer 12 (so-called adhesive residue) after pickup. On the other hand, by making the ultraviolet ray integrated radiation to be 1000 mJ/cm² or less, an excessive decrease of the adhesive strength of the pressure-sensitive adhesive layer 14 is prevented. With this, peeling between the pressure-sensitive adhesive layer 14 and the adhesive layer 12 occurs, and the mounted semiconductor wafer is prevented from falling. Further, the generation of chip fly of the semiconductor chip that is formed can be prevented when dicing the semiconductor wafer.

The value of the tensile modulus is obtained with the following measurement method. That is, a sample having a length of 10.0 mm, a width of 2 mm, and a cross section of 0.1 to 0.5 mm² is cut out from the dicing film 1. The tensile test is performed on this sample in the MD in a condition of measurement temperature 23° C., distance to a chuck of 50 mm, and tensile speed 50 mm/min, and the changing length (mm) of the sample that is due to the sample being stretched is measured. A value is made to be the tensile modulus that is obtained by drawing a tangential line at the initial rise section in the S-S (Strain-Strength) curve that is obtained from the changing length of the sample and by dividing the tensile strength of the tangential line corresponding to a 100% elongation by the cross section of the dicing film 11.

The adhesive layer 12 may have a configuration in which it is formed only on its pasting portion depending on the shape of the semiconductor wafer in a planar view. In this case, by curing the ultraviolet ray curing-type pressure-sensitive adhesive layer 14 so that it matches to the shape of the adhesive layer 12, the adhesive strength in the portion corresponding to the semiconductor wafer pasting portion can be easily decreased. Because the adhesive layer 12 is pasted to the portion where the adhesive strength decreased, the interface of the portion of the pressure-sensitive adhesive layer 14 and the adhesive layer 12 has a characteristic that they easily peel during pickup. On the other hand, the portion where the ultraviolet ray is not irradiated has sufficient adhesive strength.

As described above, in the pressure-sensitive adhesive layer 14 of the dicing die-bonding film 10, the portion that is formed with an uncured ultraviolet ray curing type pressure-sensitive adhesive adheres to the adhesive layer 12, and the holding strength when dicing can be secured. In such way, the ultraviolet ray curing-type pressure-sensitive adhesive can support the adhesive layer 12 to fix a chip-shaped semiconductor wafer such as a semiconductor chip to the adherent such as a substrate with a good balance of adhering and peeling. When the adhesive layer 12 is laminated on only the semiconductor wafer pasting portion, a wafer ring is fixed in the region where the adhesive layer 12 is not laminated.

An ultraviolet curing-type pressure-sensitive adhesive that has an ultraviolet curable functional group such as a carbon-carbon double bond and that exhibits adherability can be used as the ultraviolet curing-type pressure-sensitive adhesive without special limitation. An example of the ultraviolet curing-type pressure-sensitive adhesive is an added-type ultraviolet ray curing type pressure-sensitive adhesive to which an ultraviolet ray curable monomer component or oligomer component is compounded in a general pressure-sensitive adhesive such as an acrylic pressure-sensitive adhesive and a rubber pressure-sensitive adhesive.

The UV curing monomer component to be compounded includes, for example, polyvalent alcohol (meth)acrylates such as trimethylol propane tri(meth)acrylate, tetramethylol methane tetra(meth)acrylate, pentaerythritol tri(meth)acrylate, pentaerythritol tetra(meth)acrylate, dipentaerythritol monohydroxy penta(meth)acrylate, dipentaerythritol hexa(meth)acrylate, 1,4-butane diol di(meth)acrylate, tetraethylene glycol di(meth)acrylate, 1,6-hexane diol (meth)acrylate, neopentyl glycol di(meth)acrylate etc.; ester acrylate oligomers; and isocyanurates or isocyanurate compounds such as 2-propenyl-3-butenyl cyanurate, tris(2-methacryloxyethyl) isocyanurate etc. The UV curing oligomer component includes various acrylate oligomers such as those based on urethane, polyether, polyester, polycarbonate, polybutadiene etc., and their molecular weight is preferably in the range of about 100 to 30000. For the compounded amount of the radiation-curable monomer component or oligomer component, the amount of which the adhesive strength of the pressure-sensitive adhesive layer can be decreased can be determined appropriately depending on the type of the above-described pressure-sensitive adhesive layer. In general, the compounded amount is, for example, 5 to 500 parts by weight relative to 100 parts by weight of the base polymer such as an acrylic polymer constituting the pressure-sensitive adhesive, and preferably about 40 to 150 parts by weight.

The radiation-curing pressure-sensitive adhesive includes an internal radiation-curing pressure-sensitive adhesive using a base polymer having a carbon-carbon double bond in a polymer side chain, in a main chain or at the end of the main chain, in addition to the addition-type radiation-curing pressure-sensitive adhesive described above. The internal radiation-curing pressure-sensitive adhesive does not require incorporation of low-molecular components such as oligomer components etc., or does not contain such compounds in a large amount, and thus the oligomer components etc. do not move with time through the pressure-sensitive adhesive, thus preferably forming the pressure-sensitive adhesive layer having a stabilized layer structure.

As the base polymer having a carbon-carbon double bond, a polymer having a carbon-carbon double bond and exhibiting tackiness can be used without particular limitation. Such base polymer is preferably a polymer having an acrylic polymer as a fundamental skeleton. The fundamental skeleton of the acrylic polymer includes the acrylic polymer illustrated above.

The method of introducing a carbon-carbon double bond into the acrylic polymer is not particularly limited, and various methods can be used, and the introduction of the carbon-carbon double bond into a polymer side chain is easy in molecular design. There is, for example, a method that after a monomer having a functional group is copolymerized with the acrylic polymer, a compound having a carbon-carbon double bond and a functional group capable of reacting with the above functional group is subjected to condensation or addition reaction therewith while the radiation-curing properties of the carbon-carbon double bond is maintained.

A combination of these functional groups includes combinations of carboxylic acid group and epoxy group, carboxylic acid group and aziridyl group, or hydroxy group and isocyanate group. Among these combinations of functional groups, the combination of hydroxyl group and isocyanate group is preferable for easiness of monitoring the reaction. The functional groups may be present in either the acrylic polymer or the above compound insofar as a combination of the functional groups forms the acrylic polymer having a carbon-carbon double bond, and in the preferable combination described above, it is preferable that the acrylic polymer has a hydroxyl group, and the above compound has an isocyanate group. In this case, the isocyanate compound having a carbon-carbon double bond includes, for example, methacryloyl isocyanate, 2-methacryloyloxyethyl isocyanate, m-isopropenyl-α,α-dimethyl benzyl isocyanate. As the acrylic polymer, copolymers of the above-mentioned hydroxy group-containing monomer and an ether compound such as 2-hydroxyethyl vinyl ether, 4-hydroxy butyl vinyl ether or diethylene glycol monovinyl ether are used.

As the internal radiation-curing pressure-sensitive adhesive, the base polymer having a carbon-carbon double bond (particularly acrylic polymer) can be used solely, but the radiation-curing monomer component and the oligomer component can also be compounded to such an extent that the features of the pressure-sensitive adhesive are not deteriorated. The radiation-curable oligomer component, or the like, is in the range of 0 to 30 parts by weight relative to 100 parts by weight of a normal base polymer, and preferably in the range of 0 to 10 parts by weight.

For curing with UV rays, a photopolymerization initiator is incorporated into the radiation-curing pressure-sensitive adhesive. The photopolymerization initiator includes, for example, α-ketol compounds such as 4-(2-hydroxyethoxy)phenyl(2-hydroxy-2-propyl)ketone, α-hydroxy-α,α′-dimethyl acetophenone, 2-methyl-2-hydroxypropiophenone, 1-hydroxycyclohexyl phenyl ketone etc.; acetophenone compounds such as methoxyacetophenone, 2,2-dimethoxy-2-phenylacetophenone, 2,2-diethoxyacetophenone, 2-methyl-1-[4-(methylthio)-phenyl]-2-morpholinopropane-1 etc.; benzoin ether compounds such as benzoin ethyl ether, benzoin isopropyl ether, anisoin methyl ether etc.; ketal compounds such as benzyl dimethyl ketal etc.; aromatic sulfonyl chloride compounds such as 2-naphthalene sulfonyl chloride etc.; optically active oxime compounds such as 1-phenone-1,1-propanedione-2-(o-ethoxycarbonyl)oxime etc.; benzophenone compounds such as benzophenone, benzoylbenzoic acid, 3,3′-dimethyl-4-methoxybenzophenone etc.; thioxanthone compounds such as thioxanthone, 2-chlorothioxanthone, 2-methyl thioxanthone, 2,4-dimethyl thioxanthone, isopropyl thioxanthone, 2,4-dichlorothioxanthone, 2,4-diethyl thioxanthone, 2,4-diisopropyl thioxanthone etc.; camphor quinone; halogenated ketone; acyl phosphinoxide; acyl phosphonate etc. The amount of the photopolymerization initiator to be incorporated is for example about 0.05 to 20 parts by weight, based on 100 parts by weight of the base polymer such as acrylic polymer etc. constituting the pressure-sensitive adhesive.

The radiation-curing pressure-sensitive adhesive includes, for example, those disclosed in JP-A 60-196956, such as a rubber-based pressure-sensitive adhesive and an acrylic pressure-sensitive adhesive, comprising an addition-polymerizable compound having two or more unsaturated bonds, a photopolymerizable compound such as alkoxysilane having an epoxy group, and a photopolymerization initiator such as a carbonyl compound, an organic sulfur compound, a peroxide, an amine or an onium salt compound.

A compound that changes color with ultraviolet ray irradiation can be included in the ultraviolet ray curing type pressure-sensitive adhesive layer 14 depending on necessity. By including a compound that changes color with ultraviolet ray irradiation in the pressure-sensitive adhesive layer 14, only the portion that is radiated with the ultraviolet ray will change color. With this, whether the pressure-sensitive adhesive layer 14 is radiated with the ultraviolet ray or not can be visually determined instantly, the semiconductor wafer pasting portion is easily recognized, and the pasting of the semiconductor wafer is easy. When the semiconductor chip is detected by a light sensor, etc., the detection accuracy is improved, and no operating error occurs when picking up.

The compound that changes color with the ultraviolet ray irradiation has no color or a pale color before the ultraviolet ray irradiation. However, it is a compound that is colored by exposure to ultraviolet ray irradiation. A preferred specific example of such compound is a leuco dye. A traditional triphenylmethane-based, a fluoran-based, a phenothiazine-based, an auramine-based, and a spiropyran-based leuco dye can be preferably used as the leuco dye. Specific examples include 3-[N-(p-tolylamino)]-7-anilinofluoran, 3-[N-(p-tolyl)-N-methylamino]-7-anilinofluoran, 3-[N-(p-tolyl)-N-ethylamino]-7-anilinofluoran, 3-diethylamino-6-methyl-7-anilinofluoran, crystal violet lactone, 4,4′,4″-trisdimethylaminotriphenylmethanol, and 4,4′,4″-trisdimethylaminotriphenylmethane.

Examples of a developer that is preferably used with these leuco dyes are an initial polymer of a phenolformalin resin, an aromatic carboxylic acid derivative, and an electron acceptor such as activated clay, and various known coloring agents can be combined in the case of changing a color tone.

Such a compound that is colored by exposure to ultraviolet ray irradiation may be included in the ultraviolet ray curing type adhesive after it is dissolved in an organic solvent, or may be made into fine powder and included in the pressure-sensitive adhesive. The used ratio of this compound is desirably 10% by weight or less, preferably 0.01 to 10% by weight, and more preferably 0.5 to 5% by weight in the pressure-sensitive adhesive layer 14. When the ratio of the compound exceeds 10% by weight, the ultraviolet ray that is irradiated onto the pressure-sensitive adhesive layer 14 is absorbed excessively by this compound. Therefore, the curing of the portion corresponding to the semiconductor wafer pasting portion in the pressure-sensitive adhesive layer 14 becomes insufficient, and the adhesive strength may not decrease sufficiently. On the other hand, the ratio of the compound is preferably made to be 0.01% by weight or more to fully color.

When the pressure-sensitive adhesive layer 14 is formed with the ultraviolet ray curing-type pressure-sensitive adhesive, the portion where the adhesive strength is decreased can be formed by using the base material 13 in which the entire or a part of the portion other than the portion corresponding to the semiconductor wafer pasting portion of at least one surface of the base material 13 is shaded, forming the ultraviolet ray curing-type pressure-sensitive adhesive layer 14 on the base material 13, and curing the portion corresponding to the semiconductor wafer pasting portion by ultraviolet ray radiation. A material that can be a photo mask on the support film can be used as the shading material, and it can be produced by printing, vapor deposition, etc. According to such manufacturing method, the dicing die-bonding film 10 of the present invention can be manufactured effectively.

When curing hindrance by oxygen occurs during the ultraviolet ray irradiation, it is desirable to cut off oxygen (air) from the surface of the ultraviolet ray curing type pressure-sensitive adhesive layer 14 with some method. Examples include a method of coating the surface of the pressure-sensitive adhesive layer 14 with a separator and a method of performing the ultraviolet ray irradiation in a nitrogen gas atmosphere.

The thickness of the pressure-sensitive adhesive layer 14 is not particularly limited. However, it is preferably about 1 to 50 μm from the viewpoints of compatibility of chipping prevention of the chip cut face and holding the fixation of the adhesive layer 12, etc. It is preferably 2 to 30 μm, and further preferably 5 to 25 μm.

The above-described adhesive layer 12 is a layer having an adhesion function, and its constituting materials include a material using a thermoplastic resin and a thermosetting resin together. Further, a thermoplastic resin can be used alone.

The glass transition temperature of the adhesive layer 12 is preferably in a range of −20 to 50° C. When the glass transition temperature is −20° C. or more, a decrease of the handling property of the adhesive layer 12 caused by the tack property becoming large in the B stage state can be prevented. When dicing the semiconductor wafer, the adhesive that is melted by heat due to the friction with the dicing blade can be prevented from attaching to the semiconductor chip and causing a pickup failure. On the other hand, by making the glass transition temperature to be 50° C. or less, fluidity and adhesion with the semiconductor wafer can be prevented from decreasing.

The tensile storage modulus at 23° C. before curing of the adhesive layer 12 is preferably in a range of 50 to 2000 MPa. By making the tensile storage modulus to be 50 MPa or more, the adhesive that is melted by heat due to the friction with the dicing blade can be prevented from attaching to the semiconductor chip and causing a pickup failure when dicing the semiconductor wafer. On the other hand, by making the tensile storage modulus to be 2000 MPa or less, good adhesion with the semiconductor wafer that is mounted, a substrate that is die bonded, etc. can be obtained.

The value of the tensile storage modulus is obtained with the following measurement method. That is, the adhesive layer 12 having a thickness of 100 μm is formed by applying a solution of the adhesive composition onto a peeling liner on which a release treatment is performed and then drying. The adhesive layer 12 is left in an oven at 150° C. for 1 hour, and then the tensile storage modulus at 200° C. after curing of the adhesive layer 12 is measured using a viscoelastic measurement apparatus (model: RSA-II, manufactured by Rheometric Scientific). In more detail, a measurement sample having a sample size of length 30.0×width 5.0×thickness 0.1 mm is set in a jig for film tensile measurement, and it is measured under a condition of a temperature range of 50 to 250° C., frequency of 1.0 Hz, strain of 0.025%, and temperature increasing rate of 10° C./min.

Examples of the thermoplastic resin include natural rubber, butyl rubber, isoprene rubber, chloroprene rubber, ethylene/vinyl acetate copolymer, ethylene/acrylic acid copolymer, ethylene/acrylic ester copolymer, polybutadiene resin, polycarbonate resin, thermoplastic polyimide resin, polyamide resins such as 6-nylon (registered trademark) and 6,6-nylon (registered trademark), phenoxy resin, acrylic resin, saturated polyester resins such as PET and PBT, polyamideimide resin, and fluorine-contained resin. These thermoplastic resins maybe used alone or in combination of two or more thereof. Of these thermoplastic resins, acrylic resin is particularly preferable since the resin contains ionic impurities in only a small amount and has a high heat resistance so as to make it possible to ensure the reliability of the semiconductor element.

The acrylic resin is not limited to any especial kind, and may be, for example, a polymer comprising, as a component or components, one or more esters of acrylic acid or methacrylic acid having a linear or branched alkyl group having 30 or less carbon atoms, in particular, 4 to 18 carbon atoms. Examples of the alkyl group include methyl, ethyl, propyl, isopropyl, n-butyl, t-butyl, isobutyl, amyl, isoamyl, hexyl, heptyl, cyclohexyl, 2-ethylhexyl, octyl, isooctyl, nonyl, isononyl, decyl, isodecyl, undecyl, lauryl, tridecyl, tetradecyl, stearyl, octadecyl, and dodecyl groups.

A different monomer which constitutes the above-mentioned polymer is not limited to any especial kind, and examples thereof include carboxyl-containing monomers such as acrylic acid, methacrylic acid, carboxyethyl acrylate, carboxypentyl acrylate, itaconic acid, maleic acid, fumaric acid, and crotonic acid; acid anhydride monomers such as maleic anhydride and itaconic anhydride; hydroxyl-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)methylacrylate; monomers which contain a sulfonic acid group, such as styrenesulfonic acid, allylsulfonic acid, 2-(meth)acrylamide-2-methylpropanesulfonic acid, (meth)acrylamidepropane sulfonic acid, sulfopropyl (meth)acrylate, and (meth)acryloyloxy naphthalene sulfonic acid; and monomers which contain a phosphoric acid group, such as 2-hydroxyethylacryloyl phosphate.

Examples of the above-mentioned thermosetting resin include phenol resin, amino resin, unsaturated polyester resin, epoxy resin, polyurethane resin, silicone resin, and thermosetting polyimide resin. These resins may be used alone or in combination of two or more thereof. Particularly preferable is epoxy resin, which contains ionic impurities which corrode semiconductor elements in only a small amount. As the curing agent of the epoxy resin, phenol resin is preferable.

The epoxy resin may be any epoxy resin that is ordinarily used as an adhesive composition. Examples thereof include bifunctional or polyfunctional epoxy resins such as bisphenol A type, bisphenol F type, bisphenol S type, brominated bisphenol A type, hydrogenated bisphenol A type, bisphenol AF type, biphenyl type, naphthalene type, fluorene type, phenol Novolak type, orthocresol Novolak type, tris-hydroxyphenylmethane type, and tetraphenylolethane type epoxy resins; hydantoin type epoxy resins; tris-glycicylisocyanurate type epoxy resins; and glycidylamine type epoxy resins. These may be used alone or in combination of two or more thereof. Among these epoxy resins, particularly preferable are Novolak type epoxy resin, biphenyl type epoxy resin, tris-hydroxyphenylmethane type epoxy resin, and tetraphenylolethane type epoxy resin, since these epoxy resins are rich in reactivity with phenol resin as an agent for curing the epoxy resin and are superior in heat resistance and so on.

The phenol resin is a resin acting as a curing agent for the epoxy resin. Examples thereof include Novolak type phenol resins such as phenol Novolak resin, phenol aralkyl resin, cresol Novolak resin, tert-butylphenol Novolak resin and nonylphenol Novolak resin; resol type phenol resins; and polyoxystyrenes such as poly(p-oxystyrene). These may be used alone or in combination of two or more thereof. Among these phenol resins, phenol Novolak resin and phenol aralkyl resin are particularly preferable, since the connection reliability of the semiconductor device can be improved.

About the blend ratio between the epoxy resin and the phenol resin, for example, the phenol resin is blended with the epoxy resin in such a manner that the hydroxyl groups in the phenol resin is preferably from 0.5 to 2.0 equivalents, more preferably from 0.8 to 1.2 equivalents per equivalent of the epoxy groups in the epoxy resin component. If the blend ratio between the two is out of the range, curing reaction therebetween does not advance sufficiently so that properties of the cured epoxy resin easily deteriorate.

In the present invention, an adhesive sheet comprising the epoxy resin, the phenol resin, and an acrylic resin is particularly preferable. Since these resins contain ionic impurities in only a small amount and have high heat resistance, the reliability of the semiconductor element can be ensured. About the blend ratio in this case, the amount of the mixture of the epoxy resin and the phenol resin is from 10 to 200 parts by weight for 100 parts by weight of the acrylic resin component.

In order to crosslink the adhesive layer 12 of the present invention to some extent in advance, it is preferable to add, as a crosslinking agent, a polyfunctional compound which reacts with functional groups of molecular chain terminals of the above-mentioned polymer to the materials used when the adhesive layer 12 is produced. In this way, the adhesive property of the adhesive layer 12 at high temperatures is improved so as to improve the heat resistance.

The crosslinking agent may be one known in the prior art. Particularly preferable are polyisocyanate compounds, such as tolylene diisocyanate, diphenylmethane diisocyanate, p-phenylene diisocyanate, 1,5-naphthalene diisocyanate, and adducts of polyhydric alcohol and diisocyanate. The amount of the crosslinking agent to be added is preferably set to 0.05 to 7 parts by weight for 100 parts by weight of the above-mentioned polymer. If the amount of the crosslinking agent to be added is more than 7 parts by weight, the adhesive force is unfavorably lowered. On the other hand, if the adding amount is less than 0.05 part by weight, the cohesive force is unfavorably insufficient. A different polyfunctional compound, such as an epoxy resin, together with the polyisocyanate compound may be incorporated if necessary.

An inorganic filler can be compounded appropriately in the adhesive layer 12 depending on its use. The compounding of the inorganic filler enables an addition of electrical conductivity, an improvement of thermal conductivity, an adjustment of the elastic modulus, etc. Examples of the inorganic fillers include various inorganic powders made of the following: a ceramic such as silica, clay, plaster, calcium carbonate, barium sulfate, aluminum oxide, beryllium oxide, silicon carbide or silicon nitride; a metal such as aluminum, copper, silver, gold, nickel, chromium, lead, tin, zinc, palladium or solder, or an alloy thereof; and carbon. These may be used alone or in combination of two or more thereof. Among these, silica, in particular fused silica is preferably used. The average particle size of the inorganic filler materials is preferably in the range of 0.1 to 80 μm.

The compounded amount of the inorganic filler is preferably set to 0 to 80 parts by weight, and more preferably set to 0 to 70 parts by weight to 100 parts by weight of the organic resin component.

If necessary, other additives besides the inorganic filler may be incorporated into the adhesive layer 12 of the present invention. Examples thereof include a flame retardant, a silane coupling agent, and an ion trapping agent. Examples of the flame retardant include antimony trioxide, antimony pentaoxide, and brominated epoxy resin. These maybe used alone or in combination of two or more thereof. Examples of the silane coupling agent include β-(3,4-epoxycyclohexyl)ethyltrimethoxysilane, γ-glycidoxypropyltrimethoxysilane, and γ-glycidoxypropylmethyldiethoxysilane. These may be used alone or in combination of two or more thereof. Examples of the ion trapping agent include hydrotalcite and bismuth hydroxide. These may be used alone or in combination of two or more thereof.

The thickness of the adhesive layer 12 is not particularly limited, and is, for example, from about 5 to 100 μm, preferably from about 5 to 50 μm.

The dicing die-bonding film 10 can have an antistatic property. With this, generation of static electricity during its adhesion and peeling, breaking-down of the circuit due to the static electricity generated on a semiconductor wafer, etc., and the like can be prevented. The addition of an antistatic property can be performed with an appropriate method such as a method of adding an antistatic agent or a conductive substance into the base material 13, the pressure-sensitive adhesive layer 14, or the adhesive layer 12, and a method of providing a conductive layer consisting of a charge transfer complex or a metal film to the base material 13. A method in which impurity ions that can deteriorate the semiconductor wafer are difficult to be generated is preferable as this method. Examples of the conductive substance (conductive filler) that is compounded to add electric conductivity, to improve thermal conductivity, etc. include spherical, needle-like, flake-like metal powders of silver, aluminum, gold, copper, nickel, conductive alloys, etc., and metal oxides such as alumina, amorphous carbon black, and graphite. However, the adhesive layer 12 is preferably electrically non-conductive from the respect that there will be less electrical leakage.

The adhesive layer 12 of the dicing die-bonding film is protected by the cover film 2. The cover film 2 has a function as a protector to protect the adhesive layer 12 until its practical use. The cover film 2 is peeled when the semiconductor wafer is pasted onto the adhesive layer 12 of the dicing die-bonding film. A polyethylene terephthalate (PET) film, a polyethylene film, a polypropylene film, a plastic film of which the surface is coated with a peeling agent such as a fluorine peeling agent and a long-chain alkylacrylate peeling agent, a paper, etc. can be used as the cover film 2.

The thickness of the cover film 2 is not especially limited, and for example, it is preferably in a range of 0.01 to 2 mm, and more preferably in a range of 0.01 to 1 mm.

The first separator 21 that is pasted onto the pressure-sensitive adhesive layer 14 of the dicing film 11, the base separator 22 of the die-bonding film 24, and the second separator 23 that is pasted onto the adhesive layer 12 are not especially limited, and a conventionally known film that has undergone a peeling treatment can be used. Each of the first separator 21 and the second separator 23 has a function as a protector. The base separator 22 has a function as a base when transferring the adhesive layer 12 onto the pressure-sensitive adhesive layer 14 of the dicing film 11. The material that constitutes each of these films is not especially limited, and a conventionally known material can be adopted. Specific examples include a polyethylene terephthalate (PET) film, a polyethylene film, a polypropylene film, a plastic film of which the surface is coated with a peeling agent such as a fluorine peeling agent and a long-chain alkylacrylate peeling agent, and a paper.

In the present embodiment, a film for manufacturing a semiconductor device is explained using a dicing die-bonding film as an example. However, the present invention is not limited to this. For example, the film for manufacturing a semiconductor device may be a dicing film in which the pressure-sensitive adhesive layer and the first separator are at least laminated on the base material. It may be a die-bonding film in which the adhesive layer and the second separator are at least laminated on the base separator.

Below, preferred examples of the present invention are explained in detail. However, materials, addition amounts, and the like described in these examples are not intended to limit the scope of the present invention, and are only examples for explanation as long as there is no description of limitation in particular. In the examples, the word “part(s)” represent “part(s) by weight”, respectively, unless otherwise specified.

### Example 1

<Production of Dicing Film>

Acrylic polymer A having a weight average molecular weight of 850,000 was obtained by placing 88.8 parts of 2-ethylhexyl acrylate (below, referred to as “2EHA”), 11.2 parts of 2-hydroxyethyl acrylate (below, referred to as “HEA”), 0.2 part of benzoyl peroxide, and 65 parts of toluene in a reactor equipped with a cooling tube, a nitrogen-introducing tube, a thermometer, and a stirring apparatus, and performing a polymerization treatment at 61° C. in a nitrogen airflow for 6 hours. The molar ratio of 2EHA and HEA was made to be 100 mol: 20 mol. The weight average molecular weight is described later.

Acrylic polymer A′ was obtained by adding 12 parts (80 mol % to HEA) of 2-methacryloyloxyehyl isocyanate (below, referred to as “MOI”) into this acrylic polymer A and performing an addition reaction treatment at 50° C. in an air flow for 48 hours.

Next, a pressure-sensitive adhesive solution was produced by adding 8 parts of an isocyanate crosslinking agent (trade name “CORONATE L” manufactured by Nippon Polyurethane Industry Co., Ltd.) and 5 parts of a photopolymerization initiator (trade name “IRGACURE 651” manufactured by Chiba Specialty Chemicals) into 100 parts of the acrylic polymer A′.

A pressure-sensitive adhesive layer precursor having a thickness of 10 μm was formed by applying the prepared pressure-sensitive adhesive solution onto the surface of a PET peeling liner (the first separator) where a silicone treatment was performed and heat-crosslinking at 120° C. for 2 minutes. Next, a polyolefin film (the base material) having a thickness of 100 μm was pasted onto the surface of the pressure-sensitive adhesive layer precursor. After that, it was kept at 50° C. for 24 hours. Each of the length in the MD and the width in the TD of the polyolefin film was measured on its backside (the surface opposite to the transfer surface of the pressure-sensitive adhesive), and marking was performed. As a result of measurement, the length in the MD was 220 mm and the width in the TD was 300 mm.

Next, a pressure-sensitive adhesive layer was formed by peeling the PET peeling liner and directly radiating only the portion (a circular shape having a diameter of 200 mm) corresponding to the semiconductor wafer pasting portion (a circular shape having a diameter of 200 mm) of the pressure-sensitive layer precursor with an ultraviolet ray. With this, the dicing film according to the present example was produced. The irradiation condition is described later. The tensile modulus of the pressure-sensitive adhesive layer was measured with the method described later, and the tensile modulus was 20 MPa.

<Measurement of Weight Average Molecular Weight Mw>

Measurement of the weight average molecular weight Mw was performed by GPC (Gel Permeation Chromatography). The measurement condition is described below. Moreover, the weight average molecular weight was calculated by a polystyrene conversion.

Measurement apparatus: HLC-8120GPC (trade name) manufactured by Tosoh Corporation

Column: TSKgel GMH-H (S)×2 (product number) manufactured by Tosoh Corporation

Flow rate: 0.5 ml/min

Injection amount: 100 μl

Column temperature: 40° C.

Elution liquid: THF

Injection sample concentration: 0.1% by weight

Detector: a differential refractometer

<Irradiating Condition of the Ultraviolet Ray>

Ultraviolet ray (UV) irradiation apparatus: High pressure mercury lamp

Ultraviolet ray integrated radiation: 500 mJ/cm²

Output: 120 W

Irradiation Strength: 200 mW/cm²

<Production of Die-Bonding Film>

3 parts of an isocyanate crosslinking agent (trade name “CORONATE HX” manufactured by Nippon Polyurethane Industry Co., Ltd.), 25 parts of an epoxy resin (trade name “EPICOAT 1001” manufactured by Japan Epoxy Resins Co., Ltd.), 26 parts of a phenol resin (trade name “MILEX XLC-4L” manufactured by Mitsui Chemicals, Inc.), and 60 parts of spherical silica (trade name “SO-25R”, average particle size of 0.5 μm, manufactured by Admatechs) as an inorganic filler to 100 parts of an ester acrylate polymer (trade name “PARACRONW-197CM”, T_{g}: 18° C., manufactured by Negami Chemical Industrial Co., Ltd.) having ethyl acrylate-methylmethacrylate as a main component were dissolved into methylethylketone, and it was prepared so that the concentration became 21.4% by weight.

A coated layer was formed by applying the solution of this adhesive composition onto a release treatment film (base separator) with a fountain coater. This coated layer was dried by directly blowing hot air at 150° C. at 10 m/s for 2 minutes. With this, a die-bonding film was produced in which the adhesive layer having a thickness of 25 μm is laminated. A polyethylene terephthalate film (thickness of 50 μm) in which a silicone release treatment was carried out was used as the release treatment film.

<Production of Dicing Die-Bonding Film>

Next, the dicing film and the die-bonding film were pasted together so that the pressure-sensitive adhesive layer and the adhesive layer became a pasting surface. A nip roll was used for pasting, and the pasting condition was made to be a laminating temperature of 40° C. and a line pressure of 3 kgf /cm. A laminated film was produced by peeling the base separator on the adhesive layer.

A cover film consisting of a polyethylene terephthalate film (thickness of 38 μm) was pasted onto the adhesive layer of this laminated film. A nip roll was used for pasting, and the pasting was performed at a laminating temperature of 25° C. and a nip pressure of 0.3 MPa. The pasting was performed in a state in which the cover film was stretched at 1.003 times the initial state by applying 17 N of tensile force to the cover film using a dancer roll. With this, the dicing die-bonding film according to the present example was produced. The dicing die-bonding film was wound up to a roll and the winding tension was made to be a level of which the laminated film before pasting the cover film does not stretch, that is, specifically 13 N.

### Example 2

<Production of Dicing Film>

The same dicing film in Example 1 was used as the dicing film according to the present example.

<Production of Die-Bonding Film>

2 parts of an isocyanate crosslinking agent (trade name “CORONATE HX” manufactured by Nippon Polyurethane Industry Co., Ltd.), 35 parts of an epoxy resin (trade name “EPICOAT 1001” manufactured by Japan Epoxy Resins Co., Ltd.), 37 parts of a phenol resin (trade name “MILEX XLC-4L” manufactured by Mitsui Chemicals, Inc.), and 30 parts of spherical silica (trade name “SO-25R”, average particle size of 0.5 μm, manufactured by Admatechs) as an inorganic filler to 100 parts of an ester acrylate polymer (trade name “PARACRON W-197CM”, T_{g}: 18° C., manufactured by Negami Chemical Industrial Co., Ltd.) having ethyl acrylate-methyl methacrylate as a main component were dissolved into methylethylketone, and it was prepared so that the concentration became 21.4% by weight.

A coated layer was formed by applying the solution of this pressure-sensitive adhesive composition onto a release treatment film (base separator) with a fountain coater. This coated layer was dried by directly blowing hot air at 150° C. at 10 m/s for 2 minutes. With this, a die-bonding film was produced in which the adhesive layer having a thickness of 25 μm is laminated. A polyethylene terephthalate film (thickness of 50 μm) in which a silicone release treatment was carried out was used as the release treatment film.

<Production of Dicing Die-Bonding Film>

For the dicing die-bonding film, the dicing film and the die-bonding film were pasted together so that the pressure-sensitive adhesive layer and the adhesive layer became a pasting surface. The pasting condition was made to be a laminating temperature of 40° C. and a line pressure of 3 kgf/cm. Next, the base separator on the adhesive layer was peeled, and at the same time, the cover film consisting of a polyethylene terephthalate film (thickness of 38 μm) was pasted onto the adhesive layer. A nip roll was used for pasting, and the pasting was performed at a laminating temperature of 25° C. and a nip pressure of 0.3 MPa. The pasting was performed in a state in which the cover film was stretched at 1.01 times of the initial state by applying 17 N of tensile force to the cover film using a dancer roll. With this, the dicing die-bonding film according to the present example was produced. The dicing die-bonding film was wound up to a roll and the winding tension was made to be a level of which the laminated film before pasting the cover film does not stretch, that is, specifically 23 N.

### Comparative Example 1

<Production of Dicing Film>

The same dicing film in Example 1 was used as the dicing film according to the present comparative example.

<Production of Die-Bonding Film>

The same die-bonding film in Example 2 was used as the die-bonding film according to the present comparative example.

<Production of Dicing Die-Bonding Film>

The dicing die-bonding film according to the present comparative example was produced in the same manner as Example 2 except that the tensile force to the cover film was made to be 12 N, the cover film was pasted onto the adhesive layer in almost the same state as its initial state, and the winding tension when winding up the obtained dicing die-bonding film in a roll was made to be 28 N.

### Comparative Examples 2

<Production of Dicing Film>

The same dicing film in Example 1 was used as the dicing film according to the present comparative example.

<Production of Die-Bonding Film>

5 parts of an isocyanate crosslinking agent (trade name “CORONATE HX” manufactured by Nippon Polyurethane Industry Co., Ltd.), 45 parts of an epoxy resin (trade name “EPICOAT 1001” manufactured by Japan Epoxy Resins Co., Ltd.), 47 parts of a phenol resin (trade name “MILEX XLC-4L” manufactured by Mitsui Chemicals, Inc.), and 20 parts of spherical silica (trade name “SO-25R”, average particle size of 0.5 μm, manufactured by Admatechs) as an inorganic filler to 100 parts of a polymer (trade name “PARACRON AS-3000”, T_{g}: −36° C., manufactured by Negami Chemical Industrial Co., Ltd.) having butylacrylate as a main component were dissolved into methylethylketone, and it was prepared so that the concentration became 21.4% by weight.

A coated layer was formed by applying the solution of this adhesive composition onto a release treatment film (base separator) with a fountain coater. This coated layer was dried by directly blowing hot air at 150° C. at 10 m/s for 2 minutes. With this, a die-bonding film was produced in which the adhesive layer having a thickness of 25 μm is laminated. A polyethylene terephthalate film (thickness of 50 μm) in which a silicone release treatment was carried out was used as the release treatment film.

<Production of Dicing Die-Bonding Film>

The dicing die-bonding film according to the present comparative example was produced in the same manner as Comparative Example 1.

### Reference Example 1

<Production of Dicing Film>

The same dicing film in Example 1 was used as the dicing film according to the present reference example.

<Production of Die-Bonding Film>

The dicing film according to the present reference example was produced in the same manner as Example 1 except that the added amount of the inorganic filler was changed to 95 parts.

<Production of Dicing Die-Bonding Film>

The dicing die-bonding film according to the present reference example was produced in the same manner as Example 1.

(Method of Measuring the Tensile Modulus of the Pressure-Sensitive Adhesive Layer)

A sample having a length of 10.0 mm, a width of 2 mm, and a cross section of 0.1 to 0.5 mm² was cut out from the dicing film of each of the Examples and Comparative Examples. The tensile test was performed on this sample in the MD in a condition of measurement temperature 23° C., distance to a chuck 50 mm, and tensile speed 50 mm/min, and the changing length (mm) of the sample that was due to the sample being stretched was measured. A value was made to be the tensile modulus that was obtained by drawing a tangential line at the initial rise section in the S-S (Strain-Strength) curve that was obtained from the changing length of the sample and by dividing the tensile strength of the tangential line corresponding to a 100% elongation by the cross section of each dicing film.

(Method of Measuring the Tensile Modulus of the Adhesive Layer)

The die-bonding film in each of the Examples and Comparative Examples was left in an oven at 150° C. for 1 hour, and then the tensile modulus at 200° C. after curing of the adhesive layer was measured using a viscoelastic measurement apparatus (model: RSA-II, manufactured by Rheometric Scientific). In more detail, a measurement sample having a sample size of length 30.0×width 5.0×thickness 0.1 mm was set in a jig for film tensile measurement, and it was measured under a condition of a temperature range of 50 to 250° C., frequency of 1.0 Hz, strain of 0.025%, and the temperature increasing rate of 10° C./min.

(Shrinkage)

The shrinkage in the MD and in the TD of the dicing die-bonding film that was obtained in each of the Examples and Comparative Examples were obtained as follows. That is, each cover film was peeled from each dicing die-bonding film under an environment of temperature 23±2° C. and relative humidity 55±5% , and the dicing die-bonding film was left for 24 hours. Then, the length in the MD and the width in the TD of the dicing die-bonding film after peeling the cover film were measured. The shrinkage in the MD and the TD was calculated with the following formula using the obtained measurement values. The result is shown in Table 1.

Shrinkage (%)=[(Distance in the MD or the TD before pasting)−(Distance in the MD or the TD after pasting)/(Distance in the MD or the TD before pasting)]×100

(Film Floating)

Confirmation of the film floating of the dicing die-bonding film that was obtained in each of the Examples and Comparative Examples was performed as follows. That is, each dicing die-bonding film was left for 120 hours under an environment of temperature 23±2° C. and relative humidity 55±5%. After that, whether there is peeling or not of the pressure-sensitive adhesive layer and the adhesive layer at the interface was confirmed. For the evaluation criteria of the film floating, the case that the film floating was not observed visually was made to be ◯, and the case that it was observed was made to be ×.

(Presence of Voids)

Whether there is a void or not in the dicing die-bonding film that was obtained in each of the Examples and Comparative Examples was confirmed as follows. That is, the cover film was peeled from each dicing die-bonding film, and a semiconductor wafer was mounted on the adhesive layer. A semiconductor wafer having a size of 8 inches and a thickness of 75 μm was used. The mounting condition of the semiconductor wafer was as follows.

<Pasting Condition>

Pasting apparatus: RM-300 manufactured by ACC Co., Ltd.

Pasting speed meter: 50 mm/sec

Pasting pressure: 0.2 MPa

Pasting temperature: 50° C.

Next, whether there were voids (air bubbles) or not in the pasting surface of the dicing die-bonding film and the semiconductor wafer was confirmed with a microscope. The result is shown in Table 1.

(Evaluation of the Pickup Property)

The cover film was peeled from each dicing die-bonding film, and a semiconductor wafer was mounted on the adhesive layer. A semiconductor wafer having a size of 8 inches and a thickness of 75 μm was used. The mounting condition of the semiconductor wafer was made to be the same as above.

Next, the semiconductor wafer was diced, and then, the formed semiconductor chip was picked up with the adhesive layer. The picking up was performed on 30 semiconductor chips (5 mm×5 mm), and the success rate was calculated by counting the cases in which the picking up of the semiconductor chip was successful without damage. The dicing condition and the pickup condition were as follows.

<Dicing Condition>

Dicing method: Single cut

Dicing apparatus: DISCO DFD651 manufactured by DISCO Corporation

Dicing speed: 30 mm/sec

Dicing blade: 2050-HECC

Dicing blade rotational speed: 40,000 rpm

Dicing tape cut-in depth: 20 μm

Wafer chip size: 5.0 mm square

<Picking Up Condition>

Picking up apparatus: CPS-100 manufactured by NES Machinery

Number of needles: 9

Pushing up amount: 300 μm

Pushing up speed: 10 mm/sec

Drawing Down amount: 3 mm

(Result)

As is clear from Table 1, with the dicing die-bonding film of Examples 1 and 2, there was no peeling at the interface of the pressure-sensitive adhesive layer and the adhesive layer, and the phenomenon of film floating was not confirmed. The shrinkage in the MD and in the TD was able to be suppressed, and therefore, voids and the wrinkles were not generated after mounting the semiconductor wafer. Chip fly of the semiconductor chip did not occur when dicing the semiconductor wafer, and the pickup property was good. Contrary to this, with the dicing die-bonding film in Comparative Examples 1 and 2, peeling occurred at the interface of the pressure-sensitive adhesive layer, and the adhesive layer and the phenomenon of film floating was confirmed. The shrinkage in the MD and in the TD exceeded 2% in all of the Comparative Examples, and voids and the wrinkles were generated after mounting the semiconductor wafer. Damage such as a break and a crack was generated in the semiconductor chip, and the pickup success rate was low in all of the Comparative Examples. Chip fly of the semiconductor chip was observed when dicing.

TABLE 1

| | | | Com- | Com- | |
|---|---|---|---|---|---|
| | | | par- | par- | Refer- |
| | | Ex- | ative | ative | ence |
| | Exam- | am- | Exam- | Exam- | Exam- |
| | ple 1 | ple 2 | ple 1 | ple 2 | ple 1 |
| TENSILE MODULUS OF | 20 | 20 | 20 | 20 | 20 |
| THE | | | | | |
| PRESSURE-SENSITIVE | | | | | |
| ADHESIVE LAYER | | | | | |
| (MPa) | | | | | |
| TENSILE STORAGE | 1860 | 770 | 770 | 40 | 2600 |
| MODULUS OF THE | | | | | |
| ADHESIVE LAYER AT | | | | | |
| 23° C. (MPa) | | | | | |
| SHRINKAGE IN THE MD | 1.2 | 1.8 | 2.8 | 2.4 | 0.8 |
| (%) | | | | | |
| SHRINKAGE IN THE TD | 1.0 | 1.5 | 2.3 | 2.1 | 0.5 |
| (%) | | | | | |
| FILM FLOATING | ◯ | ◯ | X | X | X |
| PRESENCE OF THE | NO | NO | YES | YES | YES |
| VOIDS | | | | | |
| PICKUP SUCCESS RATE | 100 | 100 | 60 | 20 | 0 |
| (%) | | | | | |

1. A film for manufacturing a semiconductor device in which a cover film is pasted onto a laminated film, wherein
the shrinkage in the longitudinal direction and in the lateral direction in the laminated film after peeling the cover film and leaving for 24 hours at a temperature of 23±2° C. is in a range of 0 to 2% compared to the laminated film before pasting of the cover film.

2. The film for manufacturing a semiconductor device according to claim 1, wherein the laminated film is a film in which an adhesive layer is provided onto a pressure-sensitive adhesive layer which is provided on a base material of a dicing film.

3. The film for manufacturing a semiconductor device according to claim 2, wherein
the glass transition temperature of a polymer resin component in the adhesive layer is in a range of −20 to 50° C., and the tensile storage modulus at 23° C. before curing is in a range of 50 to 2000 MPa.

4. The film for manufacturing a semiconductor device according to claim 2, wherein
the pressure-sensitive adhesive layer of the dicing film is an ultraviolet ray curing type, and the tensile modulus of the dicing film at 23° C. after curing the pressure-sensitive adhesive layer with an ultraviolet ray is in a range of 1 to 170 MPa.

5. A method of manufacturing the film for manufacturing a semiconductor device in which the cover film is laminated on the laminated film, wherein
the cover film is pasted to the laminated film in a condition of which the cover film is stretched by applying a tensile force on the cover film in the longitudinal direction, and the shrinkage in the longitudinal direction and the lateral direction in the laminated film after peeling the cover film and leaving it for 24 hours at 23±2° C. is adjusted to be in a range of 0 to 2% to the laminated film before pasting the cover film.

6. The method of manufacturing the film for manufacturing a semiconductor device according to claim 5, wherein
the laminated film is produced by pasting the dicing film in which the pressure-sensitive adhesive layer is laminated on the base material and the die-bonding film in which the adhesive layer is laminated on a base separator together so that the pressure-sensitive adhesive layer and the adhesive layer become the pasting surface and then peeling the base separator from the adhesive layer.

7. The method of manufacturing the film for manufacturing a semiconductor device according to claim 5, wherein the cover film is pasted to the laminated film by stretching in the longitudinal direction at 1.001 to 1.1 times its initial state.

8. The film for manufacturing a semiconductor device according to claim 2, wherein
the tensile storage modulus at 23° C. before curing of the adhesive layer 12 is preferably in a range of 50 to 2000 MPa.

9. The film for manufacturing a semiconductor device according to claim 2, wherein
the adhesive layer comprises a thermoplastic resin and a thermosetting resin.

10. The film for manufacturing a semiconductor device according to claim 2, wherein
the thickness of the adhesive layer is 5 to 100 μm, the thickness of the pressure-sensitive adhesive layer is 1 to 50 μm, the thickness of the base material is 5 to 200 μm, and the thickness of the cover film is 0.01 to 2 mm.

11. The film for manufacturing a semiconductor device according to claim 2, wherein
the cover film is pasted to the laminated film in a condition that the cover film is stretched by applying a tensile force in the longitudinal direction so that the length of the cover film in the longitudinal direction is from 1.001 to 1.1 times its initial state.
